(19) United States
(12) Patent Application Publication
(10) Pub. No.: US 2022/0300347 A1
(43) Pub. Date: Sep. 22, 2022

(54) METHOD OF CONTENTIONS MITIGATION FOR AN OPERATIONAL APPLICATION AND ASSOCIATED SYSTEM OF CONTENTIONS MITIGATION

(71) Applicant: THALES, Courbevoie (FR)

(72) Inventors: Pierrick LAMOUR, Merignac (FR); Richard CANU, Merignac (FR); Marc FUMEY, Merignac (FR)

(21) Appl. No.: 17/698,345

(22) Filed: Mar. 18, 2022

(30) Foreign Application Priority Data
Mar. 19, 2021 (FR) 21 02772

(51) Int. Cl. G06F 9/52

(52) U.S. Cl. CPC G06F 9/52

(57) ABSTRACT

The present invention relates to a method of mitigating conflicts for an operational application implemented by an embedded platform. This method comprising the following steps:
constructing at least one first sensitive application configured to be conflicted by the operational application or at least one template application configured to impose conflicts on the operational application;
the embedded platform executing the operational application in parallel with the first sensitive application or the template application;
determining conflicts generated on the first sensitive application by the operational application or, respectively, on the operational application by the template application;
measuring the determined conflicts.

The present invention relates to a method of mitigating conflicts for an operational application.

The present invention also relates to a conflict mitigation system associated with this method.

The invention is particularly applicable in the field of multi-master embedded platforms, such as embedded platforms for use in the field of avionics.

In a manner known per se, such a multi-master platform comprises a plurality of masters and a plurality of shared resources, each master being capable of running at least one application using one or more shared resources.

In such platforms, the use of shared resources can lead to conflicts due to competing access by different masters. These conflicts usually result in uncontrolled process times. This makes it impossible to predict the operation of the platform in a deterministic way, which makes it unusable in areas where reliability is important.

In particular, in a multi-master context, access to peripherals can be problematic: Number of arbitration levels, shared internal resources, bus speed, protocol, etc. As a result, there are a multitude of interference channels to consider. If no precautions are taken by a multi-master component, it may prove to be unusable and result in a total loss of the system.

In a context where several applications are running in parallel, they unwittingly interact with each other and slow each other down. It seems obvious that each problem must be tackled at the source in order to apply an adequate means of mitigation.

Multi-core processors introduce several difficulties simultaneously:
Complexity: the complexity of a system-on-a-chip (SoC) increases further compared to single-core processors. In particular, complex arbitration devices exist in the exchange members (e.g. caches) between the different cores and with respect to the external memory.
Opacity: For protection reasons, manufacturers do not make public the sensitive parts of their architectures, in particular the interconnection components.
Conflicts in the execution of applications: Arbitration strategies and internal interconnection members result in conflicts in the execution of software. These conflicts are considered difficult to control given the previous two points.

In traditional approaches, it is necessary to identify and control all potential channels of interference between applications in order to ensure robust partitioning.

The qualification of critical applications is based on the identification and demonstration of a parameter called “WCET” (Worst Case Execution Time). In a multi-core context, this parameter must therefore take into account worst-case conflicts. This worst case depends on what is being executed on all the processor cores.

The problem to be solved is to find a method to identify and guarantee the worst case conditions related to the application and the conditions generating the conflicts, with an objective compatible with an industrial deployment (reasonably limited conflicts).

In a single-master platform, this problem does not arise because the master is alone, the applications are not executed in parallel, and the sequencing of these applications can be carried out deterministically by the operational system. Limitations are interpreted in terms of execution time only.

In a multi-master platform, there are acceleration elements to hide the problems. However, as these mechanisms have physical limits (size, performance, etc.), depending on the application and in case of overflow, problems arise.

Processor architecture also allows for the limiting of conflicts (e.g. physical segregation of the memory bus from other peripheral buses).

The state of the art includes several approaches that can be applied in the context of integrated modular avionics (IMA):
Processing of critical applications on a single core as a priority, with conflicts being shifted to less critical applications (an approach put forward by Wind River);
Bandwidth distribution between cores, and a law making it possible to assess the conflict on each one according to the allocated bandwidth. Performance is expected to be 5× higher when bandwidth is equally distributed, compared to a single core (an approach put forward by Green Hills);
Use of a collection of stressful applications in the image of a real application to characterise the conflicts of a given configuration (an approach put forward by Rapita).

These approaches all involve multi-application or multi-core integration to verify or confirm the correct behaviour of applications in the presence of other applications running in parallel.

In accordance with these approaches, the search for a worst case may be extremely complicated or even impossible, so great is the combinatorial nature of the situation.

The present invention aims to solve the above problems and to provide a method and a conflict mitigation system for solving conflict problems in a multi-master platform, without having to analyse a large combination of different applications of the platform or search for a worst case of each combination or to overestimate the various figures.

To this end, the invention relates to a method of mitigating conflicts for an operational application implemented by an embedded platform, the embedded platform comprising a plurality of cores and a plurality of shared resources, each core being capable of executing at least one application using one or more shared resources via an access channel established between that core and the corresponding shared resource allowing the use of that shared resource.

The method comprises the following steps:
constructing at least one first sensitive application configured to be conflicted by the operational application or at least one template application configured to impose conflicts on the operational application and constructed from an existing application of the platform;
the embedded platform executing the operational application in parallel with the first sensitive application or the template application;
determining conflicts generated on the first sensitive application by the operational application or, respectively, on the operational application by the template application;
measuring the determined conflicts.

In other beneficial aspects of the invention, the method comprises one or more of the following features, taken in isolation or in any technically possible combination:
the template application is determined from aggressiveness parameters of the corresponding existing application, the aggressiveness parameters of an application characterising the ability of this application to load the shared resources by generating a waiting time for at least one other application of the platform;
the aggressiveness parameters of at least one application are determined by identifying predetermined conflict patterns in the source code of that application, each predetermined conflict pattern being selected from the group comprising:
   instruction to update a shared resource;
   changing pages within the same memory bank;
   L2 cache line eviction;
   instruction generating a conflict;
the aggressiveness parameters of at least one application are determined as a function of aggressiveness criteria of the identified conflict patterns, each aggressiveness criterion being selected from the group comprising:
   maximum number of update instructions for a shared resource;
   maximum number of page changes within a given memory bank;
   maximum number of L2 cache line evictions;
   density of instructions generating a conflict;
the aggressiveness parameters of at least one application are determined by running said application in parallel with at least one second sensitive application configured to experience conflicts with said application;
the first sensitive application or, respectively, the second sensitive application generates substantially no conflicts on the corresponding application;
the first sensitive application or the second sensitive application shares at least one interference channel with the corresponding application, the or each interference channel being an access channel to a shared resource having at least a portion shared with another access channel for accessing that same resource;
in the constructing step, a template application is constructed for each existing application of the platform, the executing step in such a case comprising executing all the template applications constructed in parallel with the operational application and the determining step comprising determining conflicts generated on the operational application by each of the template applications or any combination of the template applications;
in the constructing step, only one first sensitive application is constructed.

The invention also relates to a conflict mitigation system for an operational application implemented by an embedded platform, comprising technical means adapted to implement the method as defined above.

These features and advantages of the invention will become apparent upon reading the following description, given only as a nonlimiting example, referring to the attached drawings, in which:

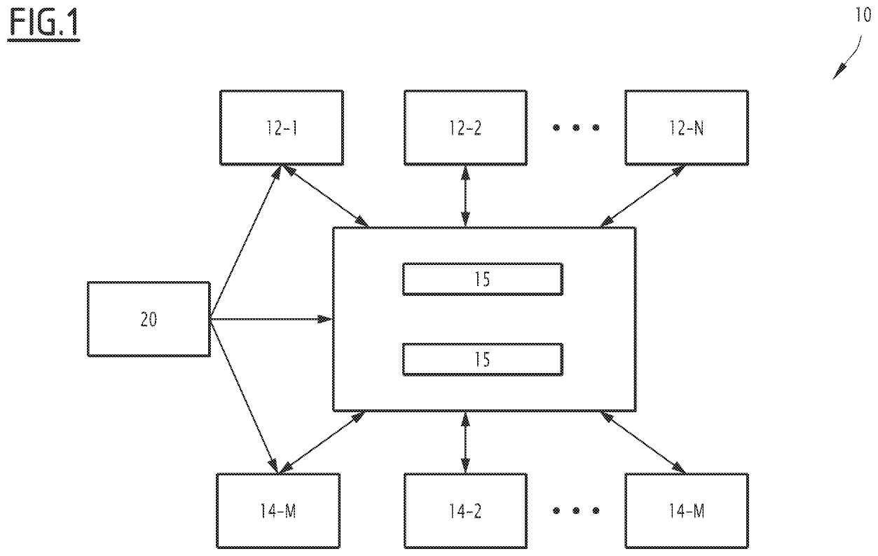

FIG. 1 is a schematic view of an embedded platform and a conflict mitigation system according to the invention, the conflict mitigation system being associated with the embedded platform;

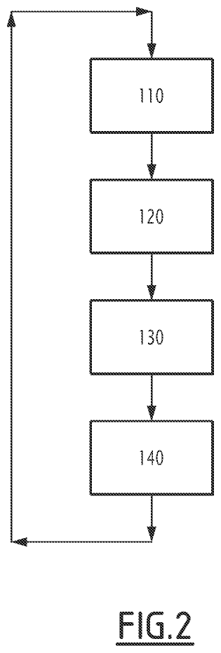

FIG. 2 is a flowchart of a conflict mitigation method according to the invention, the method being implemented by the conflict mitigation system of FIG. 1; and

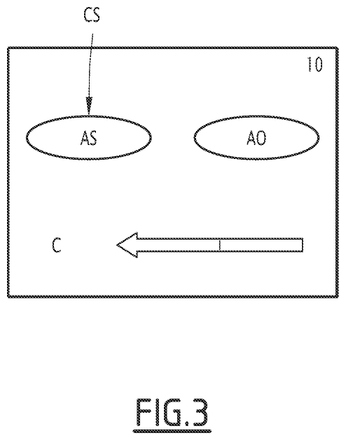

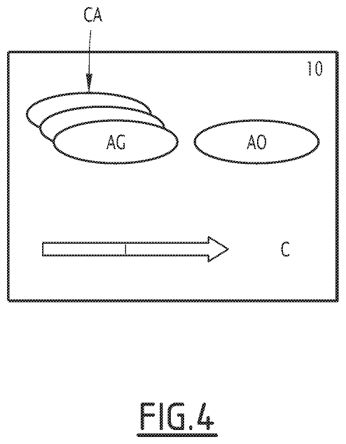

FIGS. 3 and 4 are views of different example embodiments of the method of FIG. 2.

An example embedded platform 10 is depicted in FIG. 1.

Such an embedded platform 10 has, for example, a critical system, in particular a critical avionics system. If it does, the embedded platform 10 is therefore configured to perform one or more avionics tasks.

In any event, the embedded platform 10 is designed to operate in a particular field of use. This domain therefore defines the architecture of this platform and at least some of the operating characteristics of the platform's components. In this case, the operation of the platform 10 corresponds to its nominal operation.

With reference to FIG. 1, the embedded platform comprises N cores 12-1, . . . , 12-N, M shared resources 14-1, . . . , 14-M, and one or more arbitration levels 15 between cores and resources, the numbers M and N being strictly greater than 1.

Each core 12-1, . . . , 12-N, which may also be called a processor or master, is known per se. In particular, each core 12-1, . . . , 12-N is capable of executing an application using one or more shared resources 14-1, . . . , 14-M.

For this purpose, each core 12-1, . . . , 12-N is able to, for example, send requests to at least some of the shared resources 14-1, . . . , 14-M and to receive responses to these requests.

In the following, the applications executed by cores 12-1, . . . , 12-N in the case of the nominal operation of the platform will be referred to as operational applications. For example, where the platform 10 has an avionics system, the operational applications have applications configured to implement different avionics tasks performed by such a system.

Each shared resource 14-1, . . . , 14-M has a hardware and/or possibly software component, enabling the cores 12-1, . . . , 12-N to execute the applications. By way of example, these shared resources 14-1, . . . , 14-M comprise storage space, RAM, and/or any other device known per se.

Furthermore, each shared resource 14-1, . . . , 14-M is defined by at least one characteristic of its operation. Such a characteristic may, for example, relate to a data processing capability of the corresponding resource, such as for example the write speed, read speed, throughput provided, its buffer size, etc.

Each core 12-1, . . . , 12-N is able to use one or more shared resources 14-1, . . . , 14-M via one or more arbitration levels 15 known per se.

In particular, each arbitration level 15 takes the form of, for example, one or more access buses for controlling the ability of each core 12-1, . . . , 12-N to access each resource 14-1, . . . , 14-M.

In FIG. 1, two arbitration levels are illustrated.

Like resources, each arbitration level 15 is also defined by one or more characteristics, such as transmission speed, throughput, etc.

The arbitration levels 15 thus make it possible to define access channels from the cores 12-1, . . . , 12-N to the resources 14-1, . . . , 14-N.

In particular, “access channel” means an association of a core 12-1, . . . , 12-N and a shared resource 14-1, . . . , 14-M making that resource usable by that core.

For example, an access channel may exhibit a data communication channel between the core and the corresponding resource, that data being usable by the core to execute an application.

The access channels are defined by the architecture of the platform 10 during its design stage.

The conflict mitigation system 20, also shown in FIG. 1, identifies conflicts within the platform 10 when integrating different operational applications into that platform, by implementing the conflict mitigation method explained in more detail below.

For this purpose, the conflict mitigation system 20 comprises, for example, conflict mitigation software stored in a memory provided for this purpose and executable by one or more suitable processors. This memory and these processors are, for example, part of the conflict mitigation system 20, which in this case is in the form of a computer. In another embodiment, this memory and these processors are part of an external computer.

The conflict mitigation method implemented by the conflict mitigation system 20 will now be explained with reference to FIG. 2, which shows a flowchart of its steps.

This mitigation method is implemented in relation to each operational application to be deployed on the platform 10. In other words, when a plurality of operational applications are to be deployed on the platform, the mitigation method is implemented for each of them consecutively.

Furthermore, for each of the operational applications, the mitigation method can be implemented in a first embodiment or a second embodiment. The embodiment to be applied is, for example, chosen according to the operational application for which this method is implemented.

According to the first embodiment, in a first step 110 of the method, the system 20 constructs a sensitive application configured to experience conflicts from the operational application, based on the predetermined sensitivity criteria.

In particular, by “sensitivity” of an application, we mean a potential slowdown of the application with respect to the conflicts generated by the platform 10, resulting in an increase in its execution time.

Thus, a “sensitive application” means an application that is constructed to experience conflicts from the given application. Advantageously, the sensitive application is constructed so as not to generate conflicts on the corresponding application.

To construct such a sensitive application for a given context, the system 20 analyses all access channels of this application, and among at least some of these access channels, creates interference channels.

“Interference channel” means an access channel to a shared resource that has at least one portion shared with another access channel to the same resource.

Thus, a sensitive application has at least one channel of interference with the operational application for which it was constructed. In addition, on this interference channel, the sensitive application experiences conflicts from that application.

In a particular embodiment of the invention, a single sensitive application is constructed for all operational applications. This is done, for example, by taking all interference channels into account.

In the second step 120 of the first embodiment of this method, the system 20 executes the operational application by the embedded platform 10 in parallel with the sensitive application constructed in the first step 110.

In particular, in this step 120, the operational application is executed on the platform 10 in its final deployment context: Temporal and spatial. The sensitive application is executed over the entire available time, in parallel with the operational application, but on a single free core 12-1, . . . , 12-N.

In the third step 130 of the first embodiment of the method, the system 20 determines conflicts generated on the sensitive application by the operational application. These conflicts are determined by analysing the corresponding interference channels of these applications.

In the fourth step 140 of the first embodiment of the method, the system 20 measures the conflicts determined in the previous step. This fourth step 140 is for example implemented in parallel with the third step 130.

To do this, the system 20 may, for example, count the number of execution loops of the sensitive application. The value of this counter is calibrated by isolating the sensitive application. The conflict is then measured as the difference or ratio between the number of loops actually acquired during the execution time of the operational application and the theoretical number of loops identified in isolation. This results in a conflict of the measured sensitive application, corresponding to the delay it experiences vis-à-vis the operational application.

If the conflict measurements determined in this step 140 correspond to a worst-case operating mode of the operational application, then those measurements can be used to estimate the aggressiveness of the operational application and/or to predict, for example, its maximum execution time during the nominal operation of the platform 10.

The implementation of the mitigation method according to this first embodiment is schematically illustrated in FIG. 3.

In particular, this FIG. 3 illustrates a parallel implementation of the operational application AO and the sensitive application AS constructed from the sensitivity criteria CS. The sensitive application AS then experiences interference I from the operational application AO on the corresponding interference channels, which results in conflicts C that are measured at the end of the method.

In the second embodiment of the mitigation method, in the first step 110, the system 20 builds at least one template application, instead of the sensitive application as explained in relation to the first embodiment.

In contrast to a sensitive application, a template application is constructed by the system 20 to impose conflicts on the corresponding operational application. Moreover, unlike the sensitive application, the template application is constructed from an existing application of the platform 10, i.e. from an application already integrated into the platform 10.

Advantageously, in this step 110, the system 20 constructs a template application for each existing application on the platform 10.

To construct a template application for an existing application on the platform 10, the system 20 first determines aggressiveness parameters of that existing application.

In particular, “aggressiveness parameters” of an application means parameters characterising the ability of that application to load the shared resources 14-1, . . . , 14-N by generating a waiting time for at least one other application of the platform 10, i.e. by generating conflicts in the platform 10.

Then, by analysing the aggressiveness parameters of the existing application, the system 20 constructs a template application that corresponds to a worst-case execution, in terms of conflicts, of that existing application. In other words, the template application is constructed to systematically generate at least the maximum number of conflicts that the existing application is capable of generating in a worst-case execution context.

According to the invention, the system 20 can determine the aggressiveness parameters of an existing application using two techniques.

According to a first technique, the system 20 can determine the aggressiveness parameters of an existing application by identifying predetermined conflict patterns in the source code of that application.

“Source code” means code that can be used to create the application in one or more programming languages and can therefore be interpreted by a compiler of such languages. These programming languages can be high-level and/or low-level, such as assembly language.

Each predetermined conflict pattern is selected, for example, from the group comprising:
instruction to update the context of an instruction associated with a shared resource (“with update” instruction);
changing pages within the same memory bank (e.g. address-shifting between access attempts in a DDR-type memory);
L2 cache line eviction;
instruction generating a conflict.

Thus, the system 20 determines the aggressiveness parameters of an application based on the aggressiveness criteria of the identified conflict patterns. In other words, the system 20 determines the aggression parameters by analysing the conflict patterns identified for the given application, given the predetermined aggression criteria. Each criterion of aggressiveness is chosen, for example, from the group comprising:
maximum number of update instructions for a shared resource;
maximum number of page changes within a given memory bank;
maximum number of L2 cache line evictions;
density of instructions generating a conflict.

According to a second technique, the system 20 determines the aggressiveness parameters of an application by running that application in parallel with at least one sensitive application, and by measuring the lengthening of the execution time of that sensitive application.

In other words, in this case, the system 20 determines and measures conflicts experienced by the sensitive application from the existing application using techniques similar to those described in relation to the first embodiment of the mitigation method, in which the operational application is replaced by the existing application. In this case, the measurements of the conflicts experienced by the sensitive application form the aggressiveness parameters of the existing application. According to this technique, the sensitive application is therefore constructed for the given existing application, using similar sensitivity criteria as described above.

The second step 120 of the mitigation method according to the second embodiment is analogous to the corresponding step of the method according to the first embodiment. In particular, in this step, the system 20 runs the operational application in parallel with each template application generated in the previous step.

The template applications therefore replace all other applications on the platform 10 and thus present a worst case for each corresponding existing application.

The third and fourth steps 130, 140 of the method according to the second embodiment are also similar to those explained above in relation to the first embodiment.

In particular, in the third step 130, the system 20 determines the conflicts generated on the operational application by the set of template applications. To do this, as in the previous case, the system 20 analyses the interference channels of the operational application with each template application.

In the fourth step 140, the system 20 measures the conflicts generated using techniques explained earlier. As in the previous case, the fourth step 140 can be implemented in parallel with the third step 130.

FIG. 4 illustrates the implementation of the mitigation method according to the second embodiment. In particular, in this FIG. 4, the operational application AO is executed on the platform 10 in parallel with each of the template applications AG. Each template application AG is constructed from an existing application using predetermined aggressiveness criteria CA. The template applications then generate interference I on the operational application AO, which results in conflicts C.

It is therefore clear that the present invention has a number of advantages.

In particular, the invention enables conflicts to be determined and measured using a sensitive application or a template application. In the first case, the sensitive application makes it possible to measure the aggressiveness of the corresponding operational application and thus to quantify the conflicts that can be generated by this operational application. In the second case, the template application represents a worst case of the corresponding existing application and thus quantifies the conflicts experienced by the corresponding operational application. This allows for integration independent of the operational application without having to overestimate the conflicts that the latter may generate.

The invention therefore makes it possible to anticipate, reduce, and control the deviations that applications could experience and also helps to guarantee an optimal worst-case execution time (WCET).

Finally, the invention solves the problem of dependency between applications during integration, while limiting the impact of conflicts in a worst-case context through the use of templates

1. A method of mitigating conflicts for an operational application implemented by an embedded platform, the embedded platform comprising a plurality of cores and a plurality of shared resources, each core being capable of executing at least one application using one or more shared resources via an access channel established between that core and the corresponding shared resource allowing the use of this shared resource;
the method comprising the following steps:
constructing at least one first sensitive application configured to be conflicted by the operational application or at least one template application configured to impose conflicts on the operational application and constructed from an existing application of the platform;
the embedded platform executing the operational application in parallel with the first sensitive application or the template application;
determining conflicts generated on the first sensitive application by the operational application or, respectively, on the operational application by the template application;
measuring the determined conflicts;
wherein the template application is determined from aggressiveness parameters of the corresponding existing application, the aggressiveness parameters of an application characterising the ability of this application to load the shared resources by generating a waiting time for at least one other application of the platform.

2. The method according to claim 1, wherein the aggressiveness parameters of at least one application are determined by identifying predetermined conflict patterns in the source code of that application, each predetermined conflict pattern being selected from the group comprising:
instruction to update a shared resource;
changing pages within the same memory bank;
L2 cache line eviction;
instruction generating a conflict.

3. The method according to claim 2, wherein the aggressiveness parameters of at least one application are determined as a function of aggressiveness criteria of the identified conflict patterns, each aggressiveness criterion being selected from the group comprising:
maximum number of update instructions for a shared resource;
maximum number of page changes within a given memory bank;
maximum number of L2 cache line evictions;
density of instructions generating a conflict.

4. The method according to claim 1, wherein the aggressiveness parameters of at least one application are determined by executing said application in parallel with at least one second sensitive application configured to experience conflicts from said application.

5. The method according to claim 1, wherein the first sensitive application generates substantially no conflicts on the corresponding application.

6. The method according to claim 5, wherein the first sensitive application shares at least one interference channel with the corresponding application, the or each interference channel being an access channel to a shared resource having at least a portion shared with another access channel for accessing that same resource.

7. The method according to claim 4, wherein the second sensitive application generates substantially no conflicts on the corresponding application.

8. The method according to claim 7, wherein the second sensitive application shares at least one interference channel with the corresponding application, the or each interference channel being an access channel to a shared resource having at least a portion shared with another access channel for accessing that same resource.

9. The method according to claim 1, wherein in the constructing step, a template application is constructed for each existing application of the platform, the executing step in such a case comprising executing all the template applications constructed in parallel with the operational application and the determining step comprising determining conflicts generated on the operational application by each of the template applications or any combination of the template applications.

10. The method according to claim 1, wherein in the construction step only a first sensitive application is constructed.

11. A conflict mitigation system for an operational application implemented by an embedded platform, comprising technical means adapted to implement the method according to claim 1.
